(19) United States
(12) Patent Application Publication
(10) Pub. No.: US 2014/0255761 A1
(43) Pub. Date: Sep. 11, 2014

(54) BATTERY CELL, MANUFACTURING METHOD THEREOF, AND BATTERY MODULE INCLUDING THE SAME

(71) Applicant: SK INNOVATION CO., LTD., Seoul (KR)

(72) Inventor: Ming Zhe Kong, Daejeon (KR)

(73) Assignee: SK INNOVATION CO. LTD., Seoul (KR)

(21) Appl. No.: 14/342,859

(22) PCT Filed: Oct. 12, 2012
(86) PCT No.: PCT/KR2012/008284

§ 371 Date: Mar. 5, 2014

(30) Foreign Application Priority Data
Oct. 31, 2011 (KR) 10-2011-0111991

(51) Int. Cl. H01M 2/20

(52) U.S. Cl. CPC H01M 2/204; H01M 2/206
USPC 429/157; 429/163

(57) ABSTRACT

Provided are a battery cell, a manufacturing method thereof, and a battery module including the same. According to the present invention, first and second electrode taps are formed at both sides of a case so as to be closely adhered thereto, respectively, such that the battery cell may be easily manufactured and the battery module may be easily formed by stacking.

### TECHNICAL FIELD

The present invention relates to a battery cell, a manufacturing method thereof, and a battery module including the same.

### BACKGROUND ART

Generally, a secondary battery may be recharged and be implemented as a large-capacity battery, and as a representative secondary battery, there are a nickel cadmium battery, a nickel hydrogen battery, a lithium ion battery, and the like. Among these batteries, the lithium ion battery has been prominent as a next generation power source due to excellent characteristics thereof such as long lifespan, high capacity, and the like. Among these batteries, a lithium secondary battery, which has an operating voltage of 3.6V or more, is used as a power source of portable electronic devices, or a plurality of lithium secondary batteries are connected in series with each other to thereby be used in a high power hybrid car. The lithium secondary battery has the operating voltage three times higher than that of the nickel-cadmium battery or a nickel-metal hydride battery and has excellent characteristics of energy density per unit weight, such that use of the lithium secondary battery has rapidly increased.

The lithium secondary battery may be manufactured in various shapes, and examples of a representative shape thereof include a cylinder type mainly used in the lithium ion battery and a prismatic type. A lithium polymer battery that has recently been prominent is manufactured as a flexible pouch type, such that a shape thereof is relatively free. In addition, the lithium polymer battery has an advantage in slimness and lightness for the portable electronic device due to excellent stability and a light weight thereof.

Meanwhile, in the case in which a high power lithium battery is required such as in the hybrid car, or the like, several ten to several hundred battery cells are stacked and connected in series or in parallel with each other, thereby obtaining high voltage or high current.

The battery cell includes a battery part and a case receiving the battery part therein, wherein the battery part has a configuration in which a cathode plate, a separating plate, an anode plate are stacked or wound in one direction, and the cathode plate of the battery part is electrically connected to a cathode tap and an anode tap.

The case is a pouch type case in which an intermediate layer is made of a metal foil, and inner and outer surface layers are made of an insulation film unlike a can structured case made of a thick film of a metal material in a cylindrical type or a prismatic type. The pouch type case may have excellent formability, thereby making it possible to freely bend the case.

In this case, each of the stacked battery cells is connected in series or in parallel with each other in order to be connected to a power source.

However, in order to connect the stacked battery cells in parallel with each other, the cathode taps having the same polarity and the anode taps having the same polarity should be multi-connected, respectively, and a connecting structure simultaneously connecting at least two electrodes is required according to capacity of a cell stack. Therefore, in the case in which the cathode tap and the anode tap are mechanically connected or welded, assembly performance and production efficiency may be further reduced.

In order to solve this problem, a method of ultrasonic welding a metal member to a metal terminal was suggested in Japanese Patent Laid-open Publication No. 2007-323952 (Dec. 13, 2007).

According to the method disclosed in Japanese Patent Laid-open Publication No. 2007-323952, although each of the battery cells are connected in series or in parallel with each other, which also is a process of bonding the battery cells using welding, in the case in which adhesion is reduced by external power, the entire power connection with power may be disconnected.

In addition, a bonding process is increased by the number of cells that are stacked, such that productivity may be deteriorated.

Therefore, a manufacturing method of a large-capacity battery module in which the battery cell may be easily manufactured, and power connection of a plurality of battery cells may be easily performed has been required.

### RELATED ART DOCUMENT

### Patent Document

Japanese Patent Laid-open Publication No. 2007-323952 (Dec. 13, 2007)

### DISCLOSURE OF INVENTION

### Technical Problem

An object of the present invention is to provide a battery cell capable of being easily manufactured and easily stacked to form a battery module by forming first and second electrode taps to be closely adhered to both sides of a case, a manufacturing method thereof, and a battery module including the same.

### Solution to Problem

In one general aspect, a battery cell includes: a case; a battery part provided in the case and including first and second electrode parts and a separating membrane; and first and second electrode taps connected to the first and second electrode parts and positioned at both sides of the case, respectively.

The first and second electrode taps may be welded to the first and second electrode parts, respectively.

The first and second electrode taps may be bent to be closely adhered and fixed to the case by an adhesive.

The first and second electrode taps may be fixed to outer surfaces of the case.

The first and second electrode taps may be fixed to inner surfaces of the case, and first and second hollow parts may be formed at predetermined regions of the case corresponding to the first and second electrode taps so that predetermined regions of the first and second electrode taps are exposed to the outside.

The battery cell may further include a functional plate made of a thermal conductive material or a non-conductive material between inner surfaces of the case to which each of the first and second electrode taps is bonded and the battery part.

The first and second electrode parts may protrude to the outside of the separating membrane in the case in different directions, circumferences of predetermined regions of protruding regions of the first and second electrode parts may be closely adhered and fixed to the case by an adhesive, and third and fourth hollow parts may be formed at predetermined regions of the case so that spaces enclosed by the adhesive are exposed to the outside to form the first and second electrode taps.

In another general aspect, a battery module is stacked with at least two of the battery cells described above.

The battery cell may be stacked so that a first electrode tap of one of the battery cells adjacent to each other contacts a second electrode tap of the other thereof.

The battery module may further include: a housing in which a plurality of battery cells are seated; and a pair of supporting members supporting both sides of the plurality of battery cells.

In another general aspect, a manufacturing method of a battery cell including a case, a battery part provided in the case and including first and second electrode parts, and first and second electrode taps formed at the first and second electrode parts, the method includes: a first electrode tap fixing operation of fixing the first electrode tap to the one side of the case; a second electrode tap fixing operation of positioning the case so as to enclose the battery part and fixing the second electrode tap to the other side of the case; and a case sealing operation.

Before the first electrode tap fixing operation, a welding operation of welding the first and second electrode taps to the first and second electrode parts may be further performed.

In the first electrode tap fixing operation, the first electrode tap may be bent to thereby be fixed to one side of the outer surface of the case, and in the second electrode tap fixing operation, the second electrode tap may be bent to thereby be fixed to the other side of the outer surface of the case.

In the first electrode tap fixing operation, the first electrode tap may be fixed to one side of an inner surface of the case, and in the second electrode tap fixing operation, the second electrode tap may be fixed to the other side of the inner surface of the case. In the manufacturing method of a battery, a first hollow part forming operation of cutting a predetermined region of the case corresponding to the first electrode tap so that a predetermined region of the first electrode tap is exposed to the outside after the first electrode tap fixing operation; and a second hollow part forming operation of cutting a predetermined region of the case corresponding to the second electrode tap so that a predetermined region of the second electrode tap is exposed to the outside after the second electrode tap fixing operation may be further performed.

In addition, the first and second electrode parts may protrude to the outside of the separating membrane in the case in different directions, a circumference of a predetermined region of a protruding region of the first electrode part may be fixed to one side of an inner surface of the case by the adhesive in the first electrode tap fixing operation, and a circumference of a predetermined region of a protruding region of the second electrode part may be fixed to the other side of the inner surface of the case by the adhesive in the second electrode tap fixing operation. In the manufacturing method of a battery, a third hollow part forming operation of cutting a predetermined region of the case so that a predetermined region of the first electrode tap enclosed by an adhesive is exposed to the outside to form a first electrode tap after the first electrode tap fixing operation; and a fourth hollow part forming operation of cutting a predetermined region of the case so that a predetermined region of the second electrode part enclosed by the adhesive is exposed to the outside to form a second electrode tap after the second electrode tap fixing operation may be further performed.

### Advantageous Effects of Invention

Therefore, with a battery cell, a manufacturing method thereof, and a battery module including the same according to the present invention, first and second electrode taps are formed at both sides of a case so as to be closely adhered thereto, such that the battery cell may be easily manufactured, and the battery module may be easily formed by stacking.

In addition, with the battery cell, the manufacturing method thereof, and the battery module including the same according to the present invention, sizes of the battery cell and the entire battery module may be miniaturized, and power connection through the first and second electrode taps may be easily formed, thereby making it possible to improve productivity.

### BRIEF DESCRIPTION OF DRAWINGS

The above and other objects, features and advantages of the present invention will become apparent from the following description of preferred embodiments given in conjunction with the accompanying drawings, in which:

FIGS. 1 and 2 are a perspective view and an exploded perspective view showing a battery cell according to a first exemplary embodiment of the present invention, respectively;

FIG. 3 is an exploded perspective view showing a battery cell according to a second exemplary embodiment of the present invention;

FIGS. 4 and 5 are a perspective view and an exploded perspective view showing a battery cell according to a third exemplary embodiment of the present invention, respectively;

FIG. 6 is a perspective view showing a battery cell according to a fourth exemplary embodiment of the present invention;

FIG. 7 is an exploded perspective view showing a battery cell according to a fifth exemplary embodiment of the present invention;

FIG. 8 is an exploded perspective view showing a battery cell according to a sixth exemplary embodiment of the present invention;

FIG. 9 is an exploded perspective view showing a battery cell according to a seventh exemplary embodiment of the present invention;

FIG. 10 is an exploded perspective view showing a battery cell according to an eighth exemplary embodiment of the present invention;

FIG. 11 is a cross-sectional view taken along line A-A′ when the battery cells shown in FIG. 10 are coupled to each other;

FIGS. 12 and 13 are views showing a battery module according to the exemplary embodiment of the present invention, respectively; and

FIGS. 14 to 17 are flow charts showing a manufacturing method of the battery cell according to the exemplary embodiments of the present invention.

### DETAILED DESCRIPTION OF MAIN ELEMENTS

1000: Battery module

100: Battery cell

110: Case

111: First hollow part 112: Second hollow part

113: Third hollow part 114: Fourth hollow part

120: Battery part 121: First electrode part

122: Second electrode part 123: Separating membrane

130: First electrode tap

140: Second electrode tap

150: Adhesive

160: Functional plate

200: Housing

300: Supporting member

S10˜S80: Each operation of manufacturing method of battery cell according to exemplary embodiments of present invention

### BEST MODE FOR CARRYING OUT THE INVENTION

Hereinafter, a battery cell 100 having features described above, a manufacturing method thereof, and a battery module 1000 including the same will be described in detail with reference to the accompanying drawings.

The battery cell 100 according to the present invention is configured to include a case 110, a battery part 120, a first electrode tap 130, and a second electrode tap 140.

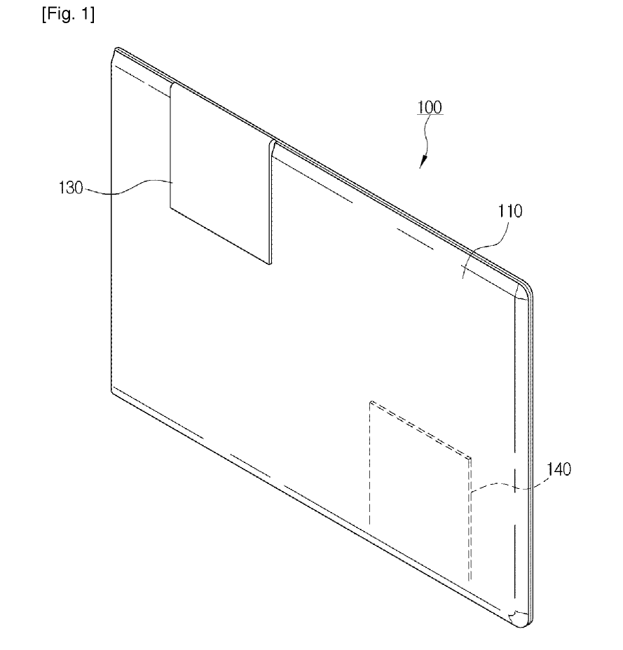

The case 110 is a basic body forming the battery cell 100 according to the present invention, and a pouch type case is shown by way of example in FIGS. 1 to 13.

The case 110 is formed so as to be sealed.

The battery part 120 is a component provided in the case 110 and is configured to include a first electrode part 121 and a second electrode part 122.

The first and second electrode parts 121 and 122 include a separating membrane 123 formed therebetween, and the first electrode 121, the separating membrane 123, and the second electrode part 122 are provided in the case 110 together with electrolytic solution.

In the battery cell 100 according to the present invention, the first and second electrode taps 130 and 140, which are components formed at the first and second electrode parts 121 and 122, respectively, for power connection, are positioned at both sides of the case 110.

Here, in the battery cell 100, the first and second electrode taps 130 and 140 may be welded to regions of the first and second electrode parts 121 and 122, respectively.

Various embodiments in which the first and second electrode taps 130 and 140 are positioned at the both sides of the case 110 are shown in FIGS. 1 to 13.

That is, each of the embodiments shown in FIGS. 1 to 13 is added in order to illustrate various embodiments of the present invention, but the battery cell 100 according to the present invention is not limited to the accompanying drawings.

### First Exemplary Embodiment

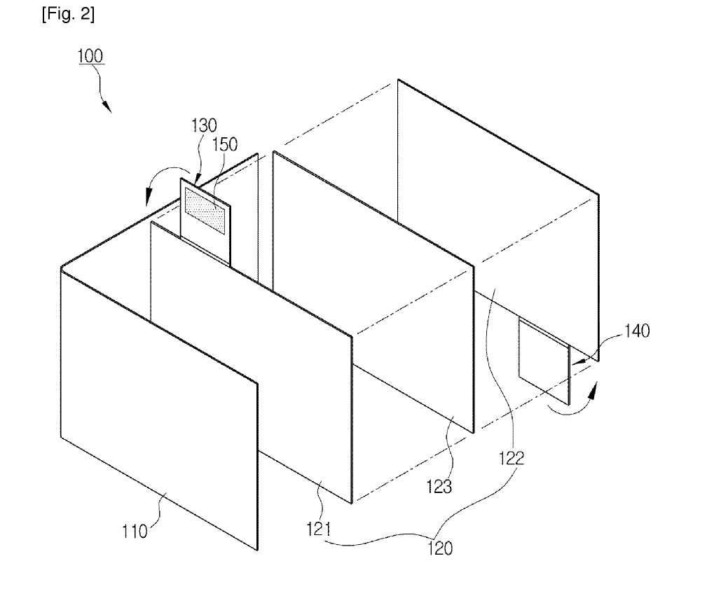

FIGS. 1 and 2 are a perspective view and an exploded perspective view showing a battery cell 100 according to a first exemplary embodiment of the present invention, respectively.

Here, the case in which the first and second electrode taps 130 and 140 are bent to thereby be closely fixed to an outer surface of the case 110 by an adhesive 150 is shown by way of example in FIGS. 1 and 2.

That is, the adhesive 150 is applied to one side of the first electrode tap 130, and a portion of the first electrode tap 130 to which the adhesive 150 is applied is adhered to an outer surface of one side of the case 110, such that the other side of the first electrode tap 130 is positioned on one side of the case 110.

In addition, the adhesive 150 is applied to one side of the second electrode tap 140, and a portion of the second electrode tap 140 to which the adhesive 150 is applied is adhered to an outer surface of the other side of the case 110, such that the other side of the second electrode tap 140 is positioned on the other side of the case 110.

In this case, the case in which the first and second electrode taps 130 and 140 protrude in different directions from each other (the first electrode tap 130 protrudes in an upward direction, and the second electrode tap 140 protrudes in a downward direction in FIG. 2) and the pouch type case 110 is bent sideward to be bonded is shown in FIGS. 1 and 2.

### Second Exemplary Embodiment

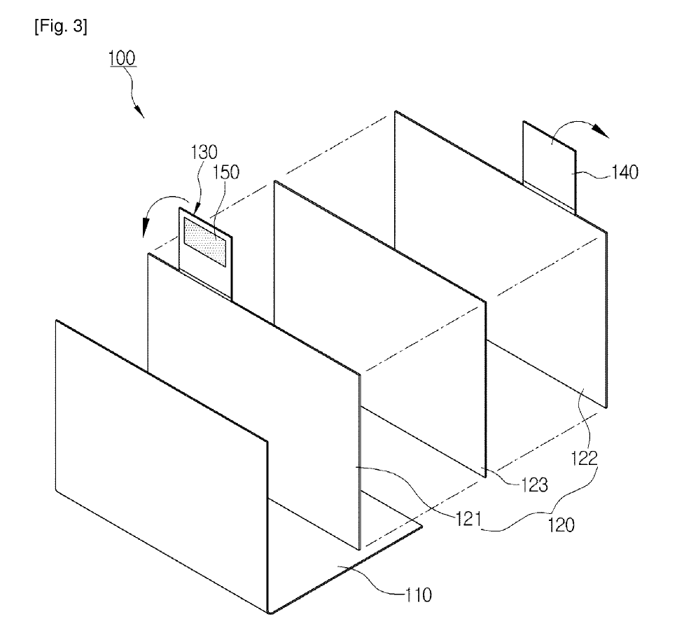

FIG. 3, which is an exploded perspective view showing a battery cell 100 according to a second exemplary embodiment of the present invention, shows an example in which the battery cell 100 has the same configurations as those of the battery cell according to the first exemplary embodiment except that first and second electrode taps 130 and 140 protrude in the same direction (an upward direction in FIG. 3) and a pouch type case 110 is bent downwardly to thereby be bonded.

The first and second exemplary embodiments described above are only some of the embodiments of the present invention, and the present invention is not limited thereto but may be more variously formed by adjusting formation positions of the first and second electrode taps 130 and 140, or the like.

### Third Exemplary Embodiment

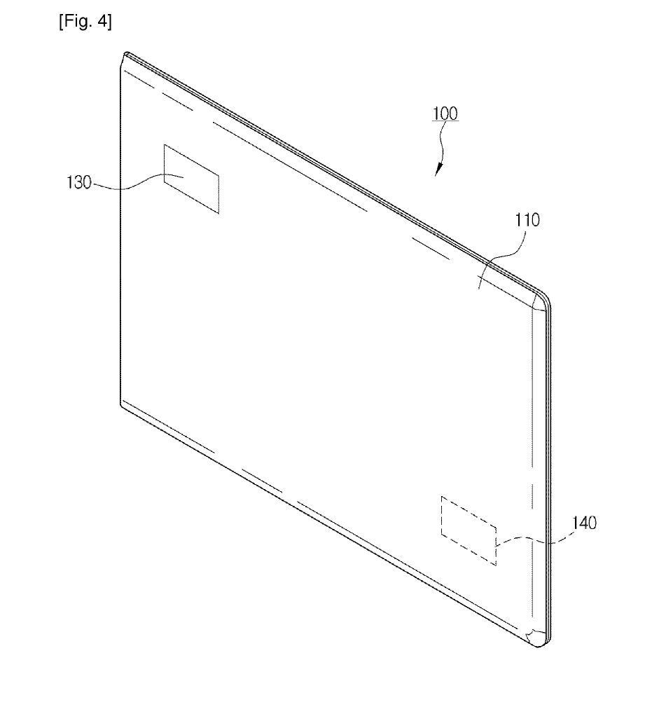

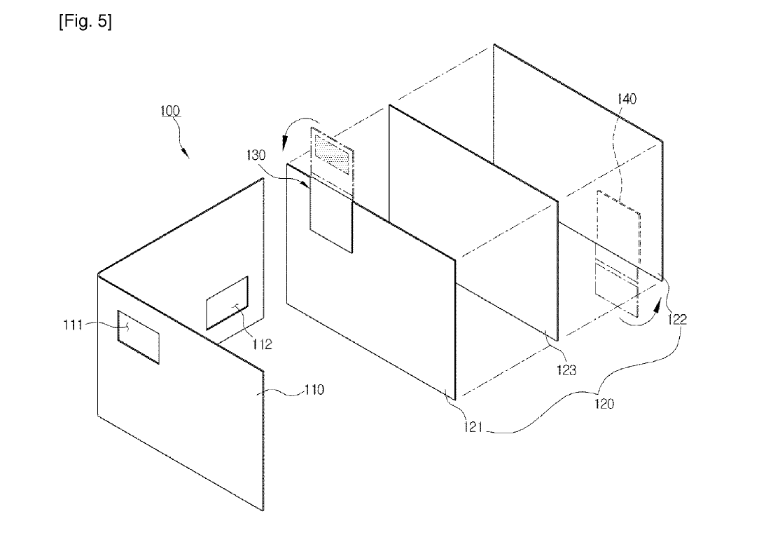

FIGS. 4 and 5 are a perspective view and an exploded perspective view showing a battery cell 100 according to a third exemplary embodiment of the present invention, respectively.

In the battery cell 100 according the third exemplary embodiment of the present invention shown in FIGS. 4 and 5, first and second electrode taps 130 and 140 are fixed to an inner surface of a case 110, and first and second hollow parts 111 and 112 are formed in the case 110 so that predetermined regions of the first and second electrode taps 130 and 140 are exposed to the outside of the case 110.

More specifically, the first and second electrode taps 130 and 140 may be fixed to the inner surface of the case 110 by an adhesive 150, and the adhesive 150 is applied to circumference parts of the first and second electrode taps 130 and 140, thereby form predetermined spaces therein.

Here, the predetermined spaces in the first and second electrode taps 130 and 140 are exposed to the outside by the first and second hollow parts 111 and 112 of the case 110, respectively, and used as components for power connection.

### Fourth Exemplary Embodiment

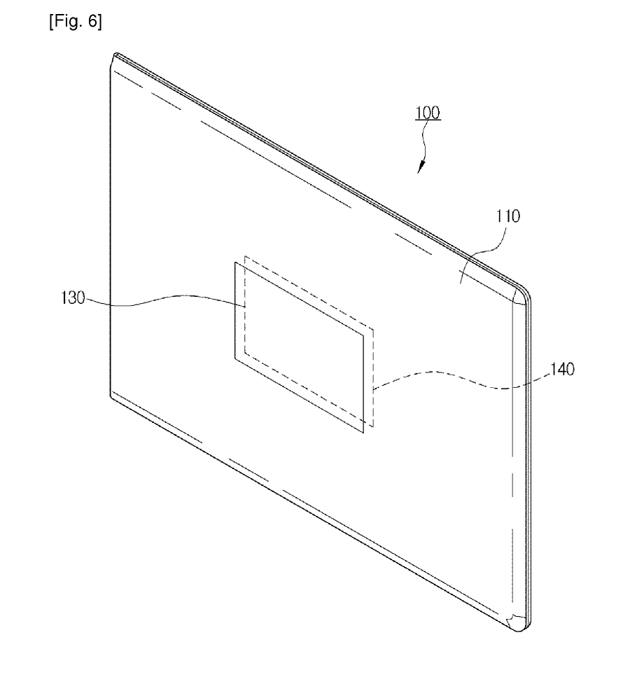

FIG. 6, which is a perspective view of a battery cell 100 according to the fourth exemplary embodiment of the present invention, shows an example in which the battery cell 100 has the same configurations as those of the battery cell according to the third exemplary embodiment except that first and second hollow parts 111 and 112 (first and second electrode taps 130 and 140) are formed at central portions of both sides of the battery cell 100, respectively.

Particularly, in the fourth exemplary embodiment of the present invention, first and second electrode taps 130 and 140 are formed at the same positions at both sides of the battery cell 100 to each other, which may be advantageous in stacking a plurality of battery cells 100.

The battery cell 100 according to the exemplary embodiment of the present invention will be more variously formed by adjusting sizes of the first and second electrode taps 130 and 140 and sizes of the first and second hollow parts 111 and 112.

### Fifth Exemplary Embodiment

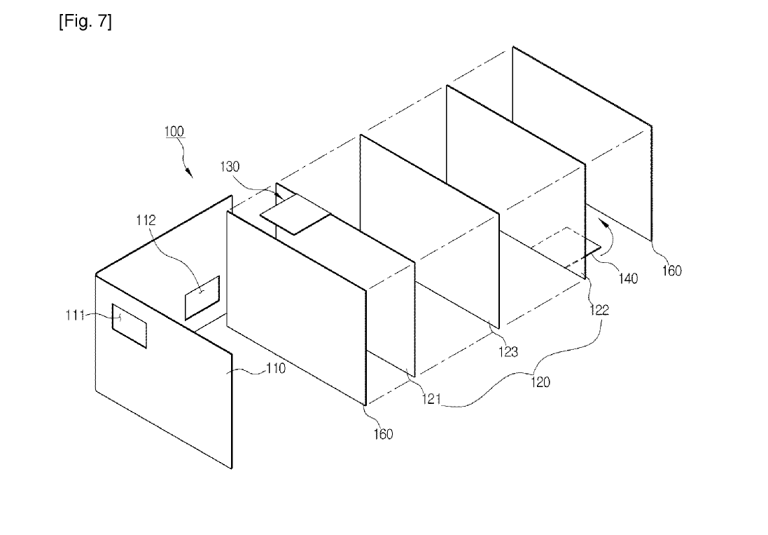

FIG. 7, which is a perspective view of a battery cell according to the fifth exemplary embodiment of the present invention, shows an example in which the battery cell 100 has the same configurations as those of the battery cell according to the third exemplary embodiment except that first and second electrode taps 130 and 140 include functional plates 160 made of a thermal conductive material or a non-conductive material between an inner surface of the bonded case 110 and a battery part 120, respectively.

The functional plate 160 may be formed at a predetermined region or the entire region of the battery part 120 in consideration of sizes and positions of the first and second electrode taps 130 and 140, and the example in which the functional plate 160 is formed so as to correspond to a size of the battery part 120 is shown in FIG. 7.

The functional plate 160 is formed, such that structural stability and formability of the entire battery cell 100 may be improved.

In addition, in the case in which the functional plate 160 is made of a thermal conductive material, the functional plate 160 assists in transferring heat generated from the first or second electrode tap 130 or 140 to radiate the transferred heat to the outside, thereby making it possible to improve heat radiating performance.

Meanwhile, in the case in which the functional plate 160 is made of a non-conductive material, electrical interference may be reduced.

### Sixth Exemplary Embodiment

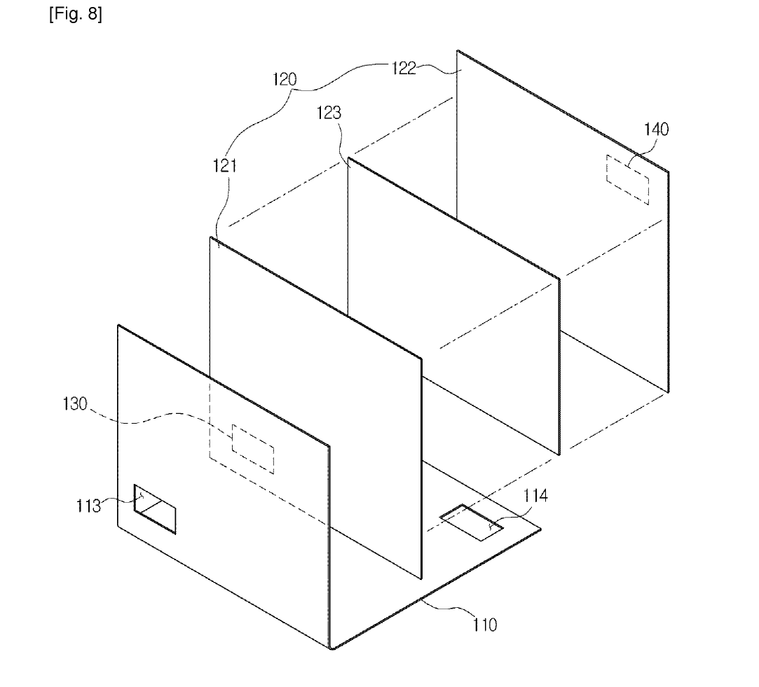

FIG. 8 is an exploded perspective view showing a battery cell 100 according to a sixth exemplary embodiment of the present invention.

In the sixth exemplary embodiment of the present invention shown in FIG. 8, first and second electrode parts 121 and 122 protrude to the outside of a separating membrane 123 in a case 110 in different directions from each other, unlike the first to third exemplary embodiments as described above in which predetermined regions of the first and second electrode parts 121 and 122 protrude to the outside of the case 110, and the first and second electrode taps 130 and 140 are welded to protruding region of the first and second electrode parts 121 and 122.

The first and second electrode parts 121 and 122 protrude in different directions from each other, which means that the first and second electrode parts 121 and 122 are formed so as to correspond to the separating membrane 123 and protrude based on the separating membrane 123, and two protruding portions are not overlapped with each other.

The case in which the first electrode part 121 protrudes downwardly and the second electrode part 122 protrudes upwardly, based on the separating membrane 123 is shown in FIG. 8.

Here, the case 110 is formed so as to receive the entire first and second electrode parts 121 and 122.

Predetermined regions of protruding regions of the first and second electrode parts 121 and 122 are adhered by an adhesive 150 so as to form predetermined spaces, respectively, and the case 110 is formed with third and fourth hollow parts 113 and 114 that are hollow at predetermined regions so that the spaces enclosed by the adhesive 150 are exposed to the outside to form first and second electrode taps 130 and 140, respectively.

That is, the case 110 is formed with the third and fourth hollow parts 113 and 114, and the spaces of the first and second electrode parts 121 and 122 enclosed by the adhesive 150 are exposed to the outside to form the first and second electrode taps 130 and 140, and the case may be sealed.

### Seventh Exemplary Embodiment

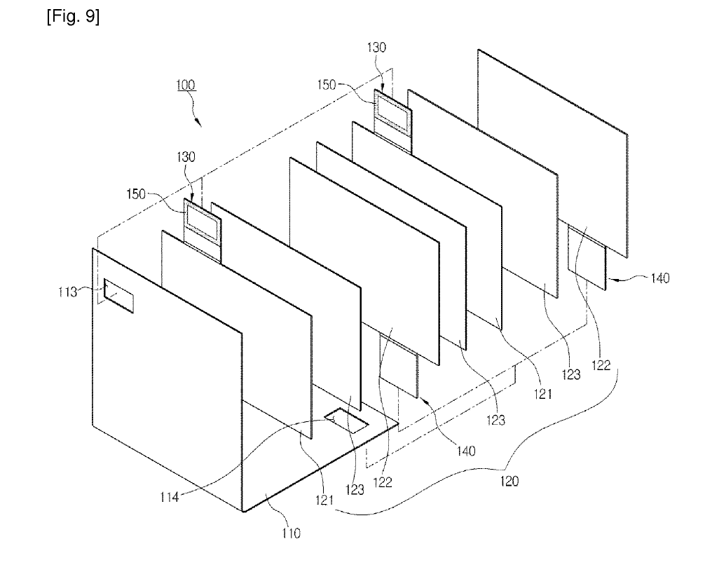

FIG. 9 is an exploded perspective view showing a battery cell 100 according to a seventh exemplary embodiment of the present invention.

In the seventh exemplary embodiment of the present invention shown in FIG. 9, an example similar to the above-mentioned sixth exemplary embodiment except that a battery part 120 has a different shape is shown.

The seventh exemplary embodiment shown in FIG. 9 shows the example in which a battery part 120 includes two first electrode parts 121, two second electrode parts 122, and three separating plates 123, and first and second electrode taps 130 and 140 are provided at each of the first and second electrode parts 121 and 122.

The first electrode taps 130 formed at each of the first electrode parts 121 are connected to each other, and one first electrode tap 130 is exposed through a third hollow part 113 of a case 110.

In addition, the second electrode taps 140 formed at each of the second electrode parts 122 are connected to each other, and one second electrode tap 140 is exposed through a fourth hollow part 114 of the case 110.

In addition to the example shown in FIG. 9, the battery cell 100 according to the present invention, the numbers of first and second electrode parts 121 and 122 and the number of separating plates 123, or the like, may be more various.

### Eighth Exemplary Embodiment

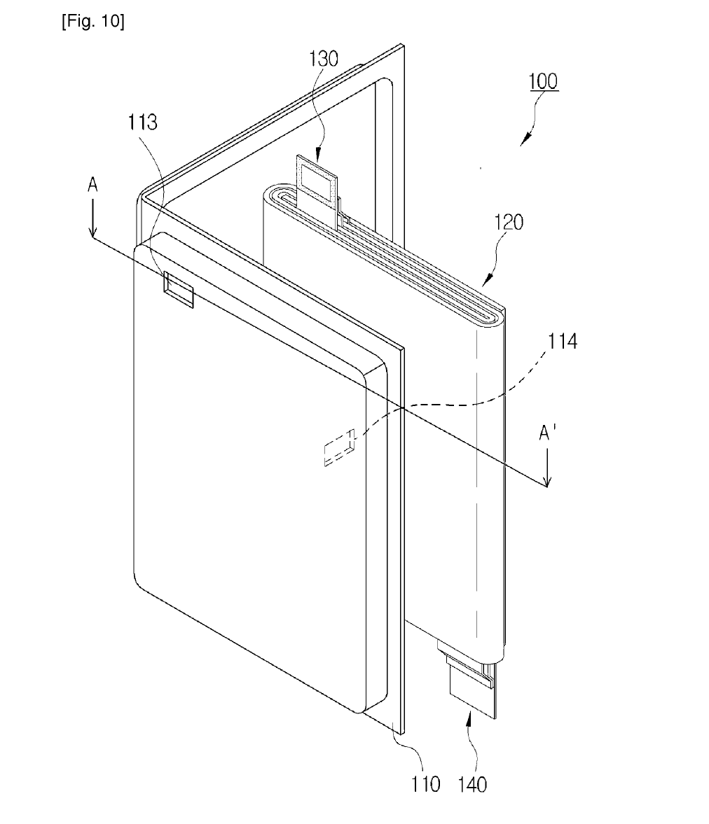

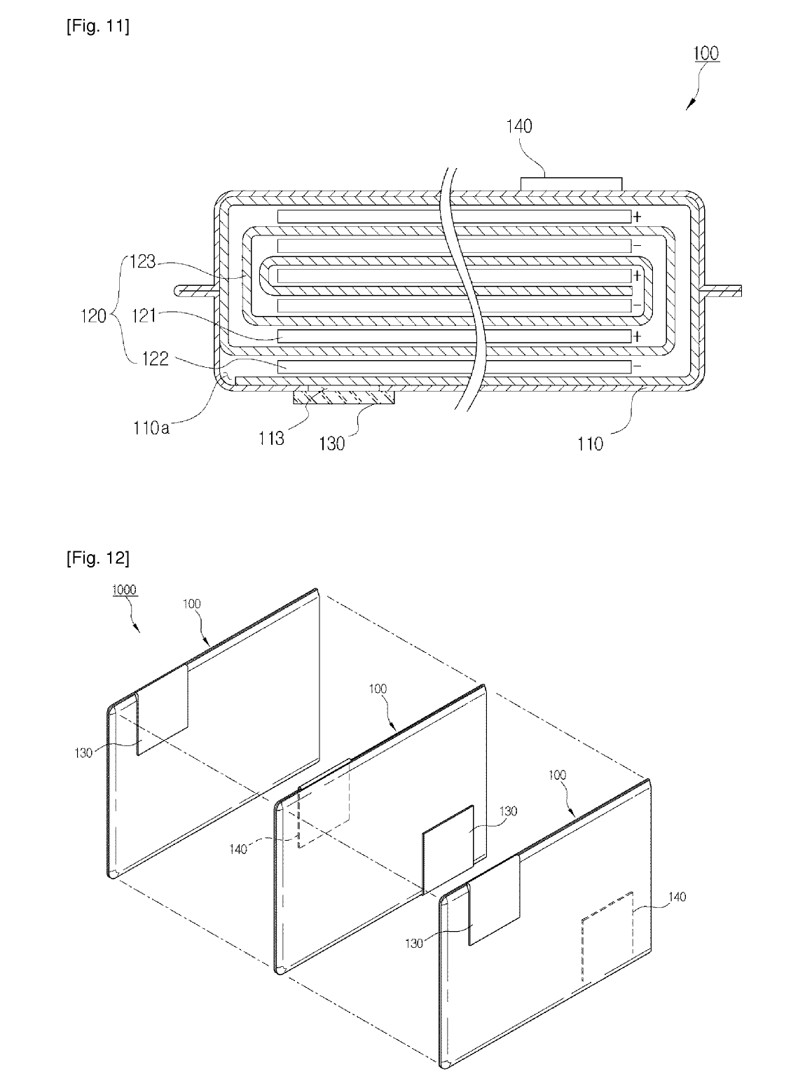

FIG. 10 is an exploded perspective view showing a battery cell 100 according to an eighth exemplary embodiment of the present invention and FIG. 11 is a cross-sectional view taken along line A-A′ when the battery cell 100 shown in FIG. 10 are coupled to each other.

In the eighth exemplary embodiment of the present invention shown in FIGS. 10 and 11, an example similar to the above-mentioned sixth and seventh exemplary embodiments except that a battery part 120 has a different shape is shown.

In the eighth exemplary embodiment, first and second electrode parts 121 and 122 are disposed on a separating membrane, which is wound, such that a battery part 120 is manufactured in a jelly-roll type, and a case 110 is formed with a space part 110a capable of receiving the jelly-roll type battery part 120.

A fourth hollow part 114 of the case 110 hid by the battery part 120 is shown by a dotted line in FIG. 10.

In addition, although the case in which the battery part 120 includes three first electrode parts 121 having a (+) polarity, three second electrode parts 122 having a (−) polarity is shown in the eighth exemplary embodiment of the present invention shown in FIGS. 10 and 11, the present invention is not limited thereto. For example, in the present invention, the number of battery parts 120 and stacking order, or the like, may be more various.

In addition to the examples shown in FIGS. 1 to 11, the battery cell 100 according to the present invention may include a battery part 120 having various shapes as long as the battery part 120 includes the first and second electrode parts 121 and 122 and the separating plate 123.

Meanwhile, in a battery module 1000 according to the exemplary embodiment of the present invention, at least two battery cells 100 as described above are stacked.

Here, as shown in FIG. 12, the battery cells 100 adjacent to each other are stacked so that the first and second electrode taps 130 and 140 having different polarities contact each other, such that a plurality of battery cells 100 may be connected in series with each other.

More specifically, a first electrode tap 130 of one of the battery cells 100 adjacent to each other of FIG. 12 contacts a second electrode tap 140 of the other thereof, and a second electrode tap 140 of one thereof contacts a first electrode tap 130 of the other thereof.

Further, a battery module 1000 according to another exemplary embodiment of the present invention may include a housing 200 including a plurality of battery cells 100 seated therein and a pair of supporting members 300 supporting both sides of the plurality of battery cells in the housing 200 in a direction in which the plurality of battery cells 100 are stacked.

The supporting member 300 allows the plurality of battery cells 100 to be closely adhered to each other, thereby facilitating connection of the first and second electrode taps 130 and 140.

Further, the supporting member 300 may prevent the battery cell 100 from moving in the housing 200, thereby improving durability.

In addition, with battery module 1000 according to the present invention, unit bodies in which a plurality of battery cells 100 is connected in series with each other is connected in parallel with each other, thereby making it possible to form a large capacitor battery pack.

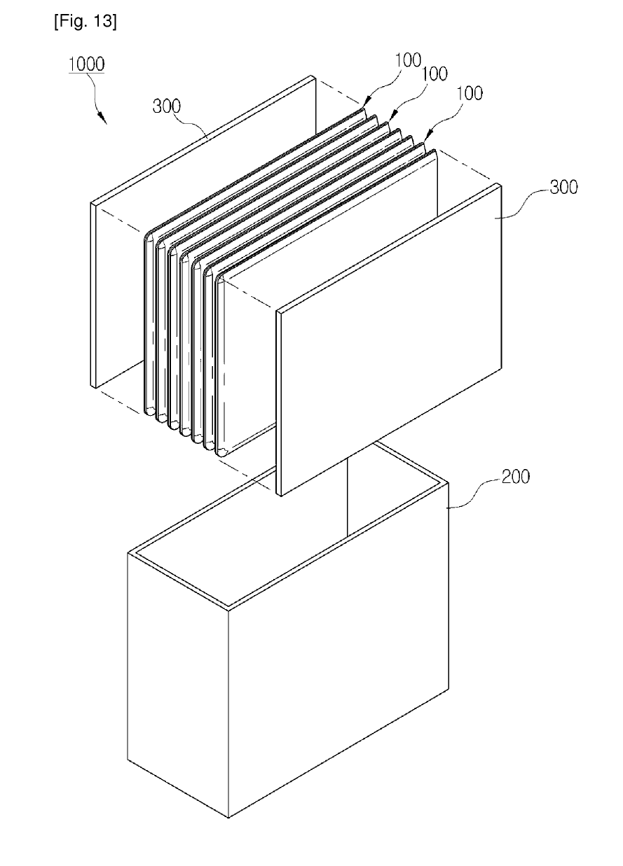

A shape shown in FIG. 13 is an example, and shapes of housing 200 and the supporting member 300 may be more various.

Meanwhile, a manufacturing method of a battery cell 100 according to the present invention is a specific method for manufacturing the battery cell 100 as described above, and flow charts of each of the embodiments are shown in FIGS. 13 to 17.

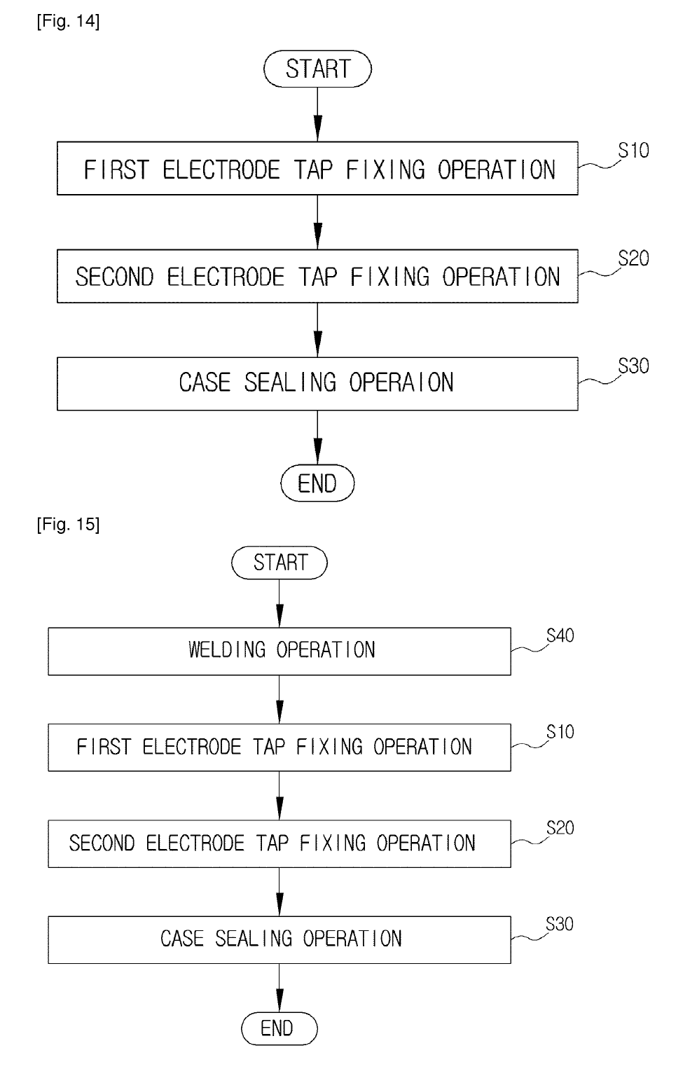

A manufacturing method of a battery cell 100 according to the present invention shown in FIG. 14 includes a first electrode tap 130 fixing operation (S10); a second electrode tap 140 fixing operation (S20); and a case sealing operation (S30).

Here, a manufacturing method of a battery cell 100 according to the present invention may further include a welding operation (S40) as shown in FIG. 15.

The welding operation (S40) is an operation of welding the first and second electrode taps 130 and 140 to first and second electrode parts 121 and 122 before the first electrode tap 130 fixing operation (S10).

FIG. 15 shows the case in which the welding operation (S40) is performed in order to manufacture the battery cell in which the first and second electrode taps 130 and 140 are welded to protruding regions of the first and second electrode parts 121 and 122 as shown in FIGS. 1 to 5.

In addition, as shown in FIGS. 1 to 3, the first and second electrode taps 130 and 140 may be closely adhered and fixed to an outer surface of the case 110.

That is, in order to manufacture the battery cell as shown in FIGS. 1 to 3, in the first electrode tap 130 fixing operation (S10), the first electrode tap 130 is bent to thereby be fixed to one side of the outer surface of the case 110, and in the second electrode tap 140 fixing operation (S20), the second electrode tap 140 is bent to thereby be fixed to the other side of the outer surface of the case 110.

The case 110 sealing operation (S30) is an operation of bonding the case so as to be sealed and may be performed by heat-fusion in the case in which the case is a pouch type.

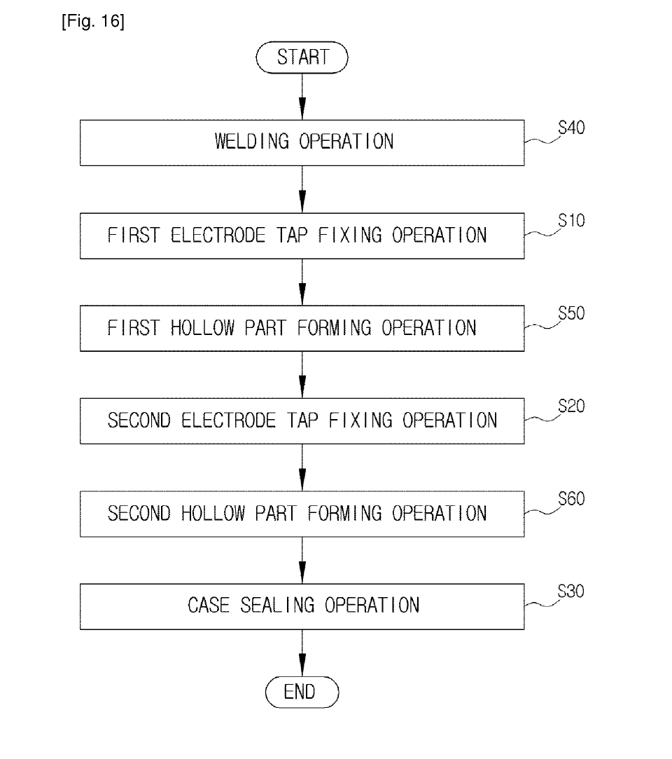

FIG. 16 shows a manufacturing method of the battery cell 100 shown in FIGS. 4 and 5. In this case, in a first electrode tap 130 fixing operation (S10), a first electrode tap 130 is fixed to one side of an inner surface of a case 110, and in a second electrode tap 140 fixing operation (S20), a second electrode tap 140 is fixed to the other side of the inner surface of the case 110.

Here, the first electrode tap 130 fixing operation (S10) and the second electrode tap 140 fixing operation (S20) may be performed so that circumference parts of the first and second electrode taps 130 and 140 are fixed to the case 110 by an adhesive 150.

Further, a first hollow part 111 forming operation (S50) of cutting a predetermined region of the case 110 to form a first hollow part 111 is performed after the first electrode tap 130 fixing operation (S10) so that a predetermined region of the first electrode tap 130 enclosed by the adhesive 150 is exposed to the outside.

In addition, a second hollow part 112 forming operation (S60) of cutting a predetermined region of the case 110 to form a second hollow part 112 is performed after the second electrode tap 140 fixing operation (S20) so that a predetermined region of the second electrode tap 140 enclosed by the adhesive 150 is exposed to the outside.

The first and second hollow parts 111 and 112 are formed so as to correspond to predetermined regions of the first and second electrode taps 130 and 140, respectively.

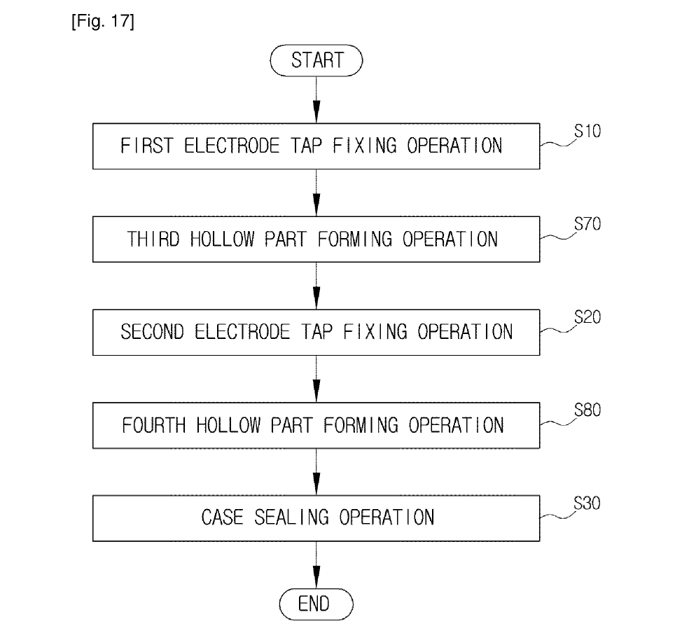

FIG. 17 shows a manufacturing method of the battery cell 100 shown in FIG. 8. In this case, first and second electrode parts 121 and 122 protrudes to the outside of a separating membrane 123 in different directions in a case 110, a circumference of a predetermined region of a protruding region of the first electrode part 121 is fixed to one side of an inner surface of the case 110 by an adhesive 150 in a first electrode tap 130 fixing operation (S10), and a circumference of a predetermined region of a protruding region of the second electrode part 122 is fixed to the other side of the inner surface of the case 110 by the adhesive 150 in a second electrode tap 140 fixing operation (S20).

Here, after the first electrode tap 130 fixing operation (S10), a third hollow part 113 forming operation (S70) of cutting a predetermined region of the case 110 to form a third hollow part 113 so that the predetermined region of the first electrode part 121 enclosed by the adhesive 150 is exposed to the outside to form the first electrode tap 130; and after the second electrode tap 140 fixing operation (S20), a fourth hollow part 114 forming operation (S80) of cutting a predetermined region of the case 110 to form a fourth hollow part 114 so that the predetermined region of the second electrode part 122 enclosed by the adhesive 150 is exposed to the outside to form the second electrode tap 140; are further performed.

That is, the third and fourth hollow parts 113 and 114 mean hollow regions formed in the case 110 when the battery part 120 having a shape shown in FIG. 8 is formed, and the first and second electrode taps 130 and 140 are positioned at both sides of the case through the third and fourth hollow parts 113 and 114, respectively.

As described above, with the battery cell 100, the manufacturing method thereof, and the battery module 1000 including the same according to the present invention, the battery cell 100 may be easily manufactured, the first and second electrode taps 130 and 140 may be positioned at both sides of the case 110, thereby easily connecting the plurality of battery cells 100 to each other by stacking, and the total size may be miniaturized due to the simple configuration thereof.

In addition, with the battery cell 100, the manufacturing method thereof, and the battery module 1000 including the same according to the present invention, a process for power connection may be simplified, thereby making it possible to improve the entire manufacturing efficiency.

The present invention should not be construed to being limited to the above-mentioned exemplary embodiment. The present invention may be applied to various fields and may be variously modified by those skilled in the art without departing from the scope of the present invention claimed in the claims. Therefore, it is obvious to those skilled in the art that these alterations and modifications fall in the scope of the present invention.

1. A battery cell comprising:
a case;
a battery part provided in the case and including first and second electrode parts and a separating membrane; and
the first and second electrode taps connected to the first and second electrode parts and positioned at both sides of the case, respectively.

2. The battery cell of claim 1, wherein the first and second electrode taps are welded to the first and second electrode parts, respectively.

3. The battery cell of claim 2, wherein the first and second electrode taps are bent to be closely adhered and fixed to the case by an adhesive.

4. The battery cell of claim 3, wherein the first and second electrode taps are fixed to outer surfaces of the case.

5. The battery cell of claim 3, wherein the first and second electrode taps are fixed to inner surfaces of the case, and first and second hollow parts are formed at predetermined regions of the case corresponding to the first and second electrode taps so that predetermined regions of the first and second electrode taps are exposed to the outside.

6. The battery cell of claim 4, further comprising functional plates made of a thermal conductive material or a non-conductive material between inner surfaces of the case to which each of the first and second electrode taps is bonded and the battery part.

7. The battery cell of claim 2, wherein the first and second electrode parts protrude to the outside of the separating membrane in the case in different directions,
circumferences of predetermined regions of protruding regions of the first and second electrode parts are closely adhered and fixed to the case by an adhesive, and
third and fourth hollow parts are formed at predetermined regions of the case so that spaces enclosed by the adhesive are exposed to the outside to form the first and second electrode taps.

8. A battery module stacked with at least two of the battery cells of claim 1.

9. The battery module of claim 8, wherein the battery cell is stacked so that a first electrode tap of one of the battery cells adjacent to each other contacts a second electrode tap of the other thereof.

10. The battery module of claim 9, further comprising:
a housing in which a plurality of battery cells are seated; and
a pair of supporting members supporting both sides of the plurality of battery cells.
